(19) United States
(12) Patent Application Publication
(10) Pub. No.: US 2020/0214921 A1
(43) Pub. Date: Jul. 9, 2020

(54) Physical Therapy Device for Intrinsic Foot Muscle Strengthening

(71) Applicant: Clifford Wolf, Los Angeles, CA (US)

(72) Inventor: Clifford Wolf, Los Angeles, CA (US)

(21) Appl. No.: 16/241,769

(22) Filed: Jan. 7, 2019

(51) Int. Cl. A61H 1/02

(52) U.S. Cl. CPC A61H 1/0266; A43B 7/141; A61H 2001/027

(57) ABSTRACT

Disclosed herein are a device for exercising intrinsic foot muscles. The device comprises a base formed of a visco-elastic material and a solid toe plate coupled to a top of the base. The toe plate is shaped to receive the curvature of the bottom of human toes so as to distribute a counterforce from pressure applied by one or more of a plurality of a person's toes among the plurality of the person's toes. The base is configured to compress as a result of the pressure received when the toe plate is gripped by the person's toes while the person's foot is positioned on top of the base. The device may be useful for treatment of plantar fasciitis, among other conditions.

### BACKGROUND

### Technical Field

Embodiments generally relate to exercise and physical therapy devices, and in particular to devices for strengthening the plantar intrinsic foot muscles.

### Background

Plantar fasciitis is a foot disorder that causes pain in the heel and bottom of the foot. It has been estimated to affect 1 in 10 people at some point during their lifetime. Although its causes are poorly understood, it is thought to have several contributing factors including inflammation, micro tears and breakdown of collagen in the plantar fascia. The plantar fascia is a thick fibrous band of connective tissue that supports the arch of the foot. Risk factors for plantar fasciitis include excessive running, standing for prolonged period of times, high arches of the feet, flat feet, and an increased body mass index.

Non-surgical treatments of plantar fasciitis usually involve a combination of rest, heat/ice, nonsteroidal anti-inflammatory drugs, orthotic shoe insoles, stretching, and strengthening exercises. Strengthening exercises include exercises focusing on the calf muscles, Achilles tendon, and plantar fascia. Recently, some studies have paid particular attention to the role of the intrinsic foot muscles (IFM) in plantar fasciitis, and the effectiveness of strengthening the IFM as a treatment. The IFM are the foot muscles originating on the dorsal or plantar aspects of the foot. It has been shown that during running the IFM slowly lengthen eccentrically during medial longitudinal arch (MLA) flattening, and subsequently shorten as the arch recoils during the propulsive phase of gait. The IFM seem to function in parallel with the plantar fascia, actively regulating the stiffness of the foot in response to the magnitude of forces encountered during running. Disfunction of the IFM leads to increase in foot pronation in static stance while walking or running, further leading to multiple inefficiencies in the use of tendons, flexors, and muscles in the foot. As such, strengthening of the IFM is desirable for patients suffering from plantar fasciitis.

### SUMMARY

Disclosed herein are a device for exercising intrinsic foot muscles. The device comprises a base formed of a visco-elastic material and a solid toe plate coupled to a top of the base. The toe plate is shaped to receive the curvature of the bottom of human toes so as to distribute a counterforce from pressure applied by one or more of a plurality of a person's toes among the plurality of the person's toes. The base is configured to compress as a result of the pressure received when the toe plate is gripped by the person's toes while the person's foot is positioned on top of the base. The device may be useful for treatment of plantar fasciitis, among other conditions.

### BRIEF DESCRIPTION OF THE DRAWINGS

FIG. 1 shows a perspective view of a device for exercising the intrinsic foot muscles of a patient, according to an example embodiment.

FIG. 2 shows a side view of a device for exercising the intrinsic foot muscles of a patient, according to an example embodiment.

FIG. 3 shows a perspective view of a foot positioned on top of a device for exercising the intrinsic foot muscles of a patient, according to an example embodiment.

FIG. 4 shows a side view of a foot positioned on top of a device for exercising the intrinsic foot muscles of a patient, according to an example embodiment.

FIG. 5 shows a side view of a foot gripping a toe plate of a device for exercising the intrinsic foot muscles of a patient, according to an example embodiment.

FIG. 6 is a flowchart for a method for using a device for exercising the intrinsic foot muscles of a patient according to an example embodiment.

In the drawings, like reference numbers generally indicate identical or similar elements. Additionally, generally, the left-most digit(s) of a reference number identifies the drawing in which the reference number first appears.

### DETAILED DESCRIPTION

Provided herein are device and method embodiments for exercising the intrinsic foot muscles of a patient.

Recently it has been shown that, during running, the intrinsic foot muscles (IFM) slowly lengthen eccentrically during medial longitudinal arch (MLA) flattening and subsequently shorten as the arch recoils during the propulsive phase of gait. The IFM seemingly function in parallel with the plantar fascia, actively regulating the stiffness of the foot in response to the magnitude of forces encountered during the running. As such, the IFM seem to act as protectors of the plantar fascia and facilitate optimal foot ground force transmission.

The IFM play a vital role in providing dynamic support of the MLA, for postural stability and maintenance of balance during single leg stance, by controlling height of the MLA and pronation. Dysfunction of the IFM leads to increase in foot pronation in static stance, while walking or running. This may lead to hypermobility and a less rigid foot during propulsion. The transition from a pronated mobile adaptor to a supinated rigid lever is inefficient. Also, with excessive pronation, the angle of pull of the Achilles tendon and plantar flexors is less than ideal. When the period of pronation is prolonged, the onset of supination is delayed and reaching neutral position is delayed well into the propulsive phase.

The function of the IFM occurs simultaneously with the “windlass mechanism,” which describes the means by which the plantar fascia supports the foot during weight-bearing activities. Windlass is the tightening of a rope or cable. The plantar fascia prevents foot collapse because of its anatomical orientation from calcaneus to metatarsal heads and its tensile strength. Dorsoflexion of the toes during propulsion, shortens the distance between the calcaneus and metatarsals by winding the plantar fascia around the metatarsal heads, thereby elevating the MLA. It functions as a tension band in the foot, providing both static support and dynamic shock absorption.

Embodiments described herein aid users in performing strengthening exercises that target improvement in IFM function as a treatment for MLA weakness or dysfunction. In particular, embodiments provide a means of performing a “short foot exercise.” A person with a lower MLA can have different pathologies that result from hypermobility and weakness to provide active MLA support. The “short foot exercise” has been described as a means to isolate contracture of the plantar IFM. The foot is shortened by using the intrinsic muscles to pull all the metatarsalphalangeal joints toward the calcaneus as the MLA is elevated. The arch rising is referred to as foot arcing.

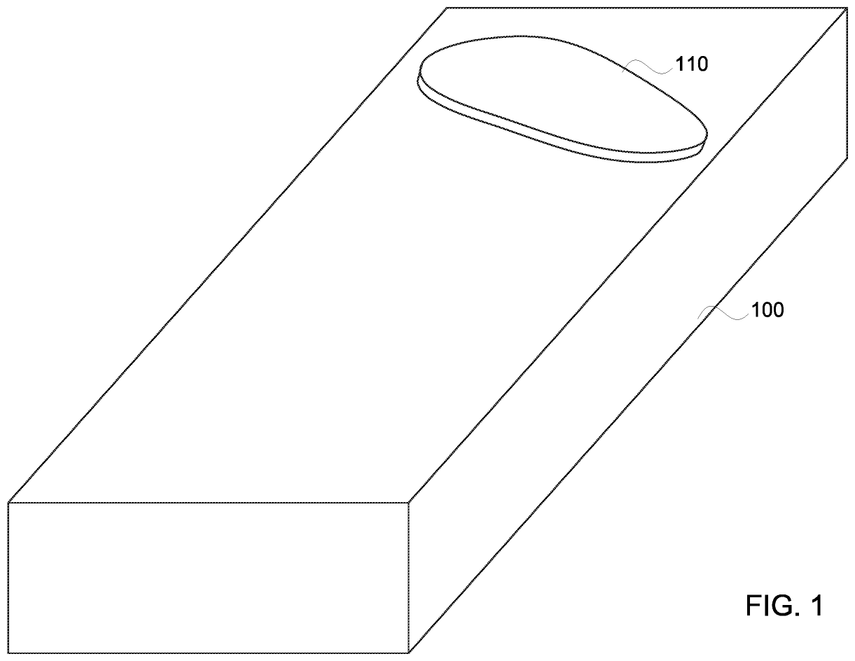

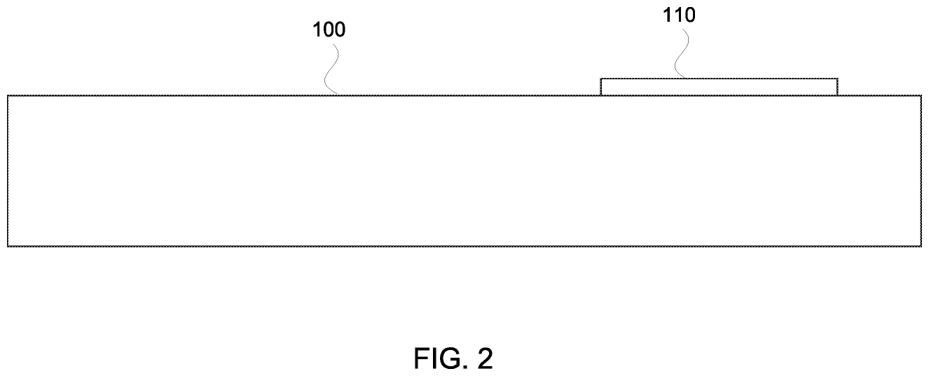

FIG. 1 shows a perspective view of a device 100 for exercising the intrinsic foot muscles of a patient, according to an example embodiment. FIG. 2 shows a side view of a device 100 for exercising the intrinsic foot muscles of a patient, according to an example embodiment. Device 100 comprises a base 110 coupled to a toe plate 120. Base 110 may be a rectangular cuboid shape, as shown in FIG. 1. However, the base can take any suitable shape, such as circular, polygonal, etc. In particular embodiments, the base is large enough accommodate a typical person's entire foot, from toe to heel.

In particular embodiments, base 110 is configured to compress as a result of the pressure received when the toe plate is gripped by the person's toes while the person's foot is positioned on top of the base. In particular embodiments, base 110 is made of a visco-elastic material, such as, by way for example, a block of foam material, a sponge, etc. In particular embodiments, base 110 is made of a polyether polyurethane material. In particular embodiments, base 110 is made of a Bergad® specialty foam formulation 6000. In particular embodiments, base 110 is made of a foam material that has an indentation forced deflection (at 25% deflection) test result of 32 lbf or higher. While particular embodiments are described throughout this disclosure for the base 110 and toe plate 120, this disclosure contemplates any suitable material or combination of materials that can achieve the activation of the IFM as described herein.

Toe plate 120 may be a solid plate made of any suitable rigid material, such as, for example, plastic, metal, wood, rubber, etc. In particular embodiments, toe plate 120 is made of a material that maintains rigidity when gripped with the ordinary strength of a person's toe grip.

Base 110 and toe plate 120 may be permanently attached together, removably attached together, or not attached at all. As an example, the base 110 and the solid toe plate 120 may be connected to each other via an adhesive, stitching, hook and loop fabrics (e.g., Velcro®), etc. In particular embodiments, a user may simply place the toe plate on top of the base without otherwise attaching the plate to the base.

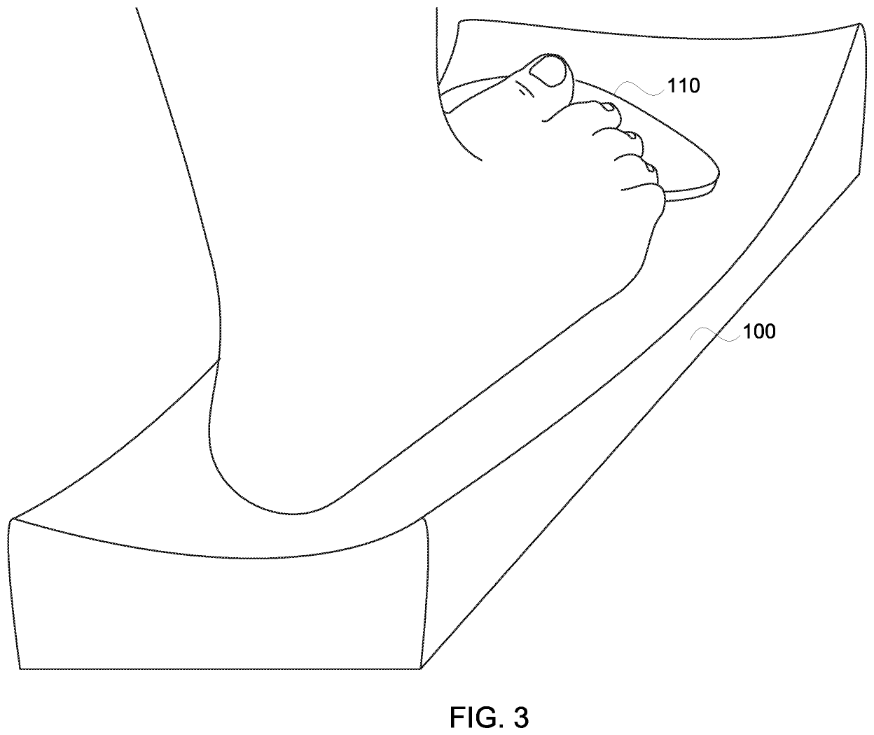

As described above, toe plate 120 maintains rigidity when gripped with the ordinary strength of a person's toe grip. A person would perform a short foot exercise by standing his/her their foot on top of the base and with his/her toes on top of the toe plate, as shown in FIGS. 3-5. The person would then squeeze or grip the sponge through the toe plate. Since the toe plate is rigid, but the base is a yielding foam material, the person can apply force with all of his/her toes simultaneously, thus achieving increased activation of the IFM. In essence, the toe plate acts to distribute the counterforce from pressure applied by the toes among the plurality of the person's toes, thus forcing the toes to activate all toes simultaneously and thus increase activation of the IFM.

In this manner, device 100 may achieve increased strengthening of the IFM compared with traditional therapeutic toe flexion exercises for the IFM, such as towel curls or marble pick-ups. While these exercises activate very few of the plantar IFM, they also involve substantial activation of the flexor hallucis longus and flexor digitorum longus muscles, which are extrinsic muscles.

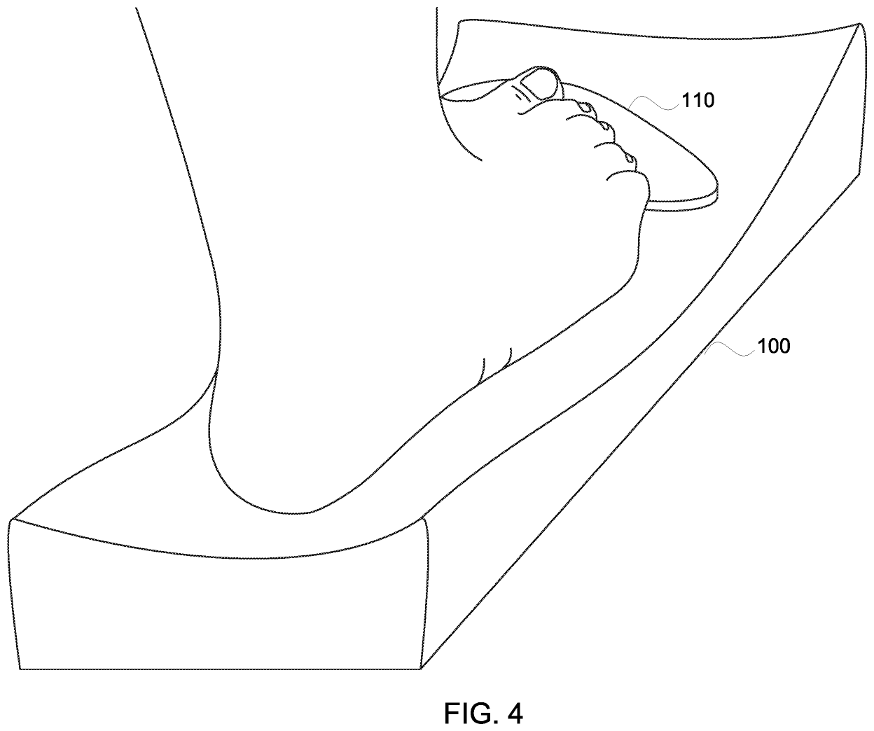

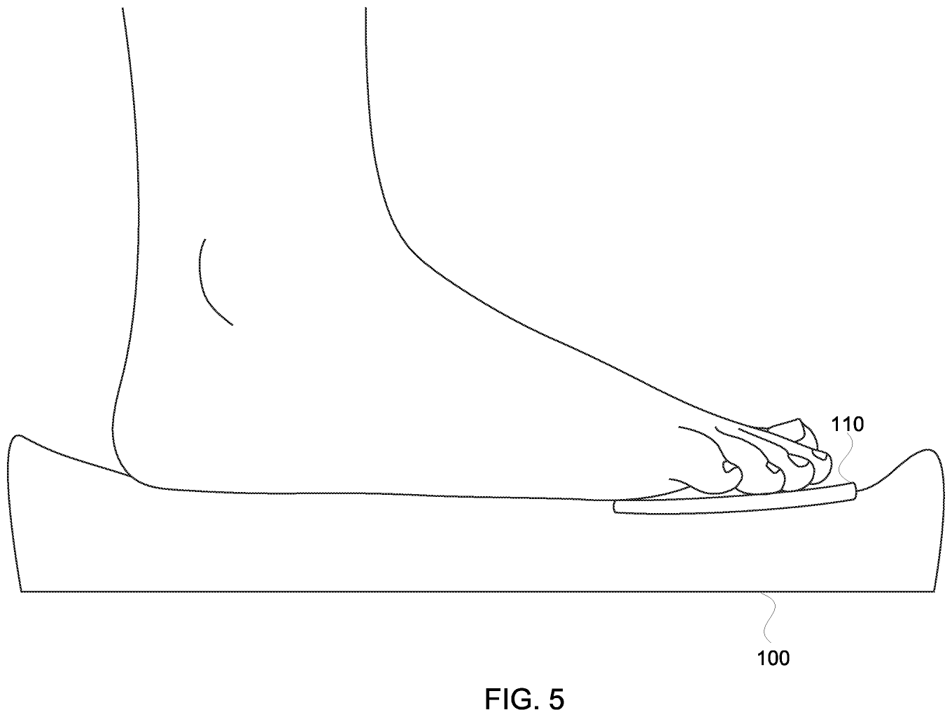

FIG. 4 shows a side view of a foot positioned on top of a device for exercising the intrinsic foot muscles of a patient, according to an example embodiment. FIG. 5 shows a side view of a foot gripping a toe plate of a device for exercising the intrinsic foot muscles of a patient, according to an example embodiment.

The short foot exercise is an isokinetic closed kinetic chain exercise for strength training. It is performed at a dynamic fixed speed with resistance that is accommodating throughout the range of motion with the foot stationary. Accommodating resistance means that isokinetic exercise is the only way to dynamically load a muscle (or muscle group) to its maximum capacity throughout every point in the range of motion, so resistance varies to exactly match the force applied. It typically blends intense contractions of isometric exercise with the range of motion achieved in isotonic exercise to provide maximum strength workout.

With this type of training a patient is incapable of straining his/her muscles or causing body damage due to overuse so it is optimal for muscle rehabilitation and recovery, as well as injury prevention. The isokinetic nature of the short foot exercise allows isolation of the plantar IFM for most effective strength training. As shown in FIG. 4, a patient places his/her foot flat on the base 110 with the toes neither flexed nor extended resting on top of the toe rest plate 120, which is thus placed beneath all toes and on top of the sponge. The foot thus remains in a subtalar neutral position, where the bisection of the heel (where the Achilles tendon attaches) seems substantially perpendicular to the ground beneath the base 110. In an ideal usage, the patient should align the center of the patella with the second toe, and the foot is at 90 a degree angle to the leg.

Once the foot is in the proper position, foot arcing is performed, as shown in FIG. 5. The heel remains in place on the base 110. The patient may hold the arc by gripping the sponge as hard he/she can, pressing all toes down at the same time onto the toe rest plate, pulling all metatarsals toward the heel. The patient may hold the arc for a few seconds, e.g., 5 seconds. The patient may then relax for another time period (e.g., 5 seconds) and repeat exercise. The patient may repeat the exercise for a few sets (e.g., three sets of six repetition), and increase the time of the hold as indicated by a doctor, (e.g., up to 10 seconds before releasing).

There is evidence to suggest that four weeks of short foot exercise performed daily, reduces arch collapse as accessed by measure of navicular drop, arch height index and improved balance ability. In another study, short foot exercise demonstrated improved dynamic balance as compared to four weeks of towel curl exercises.

In another study after four weeks of short foot exercise and orthotic intervention, participants with flat feet saw significant increases in great toe flexion strength and the cross-sectional area of the abductor hallucis muscle as compared to foot orthotic intervention alone. In another study, after four weeks of short foot exercise, there was improved function in chronic ankle instability patients during balance exercises compared to a group who did not perform “short foot exercises”.

Current clinical guidelines include the use of foot Orthotics for heel pain and Plantar Fasciitis but lack reference to strengthening of the IFM. Although temporary external support may be necessary in an initial therapeutic regimen for Plantar Fasciitis, it should be in conjunction with a strengthening program. Training with the device described herein may not only benefit injuries resulting from hypermobility and excessive pronation but also in the rehabilitation of many lower extremity and foot pathologies by targeting the Plantar Intrinsic Foot muscles with “short foot exercises” for strengthening.

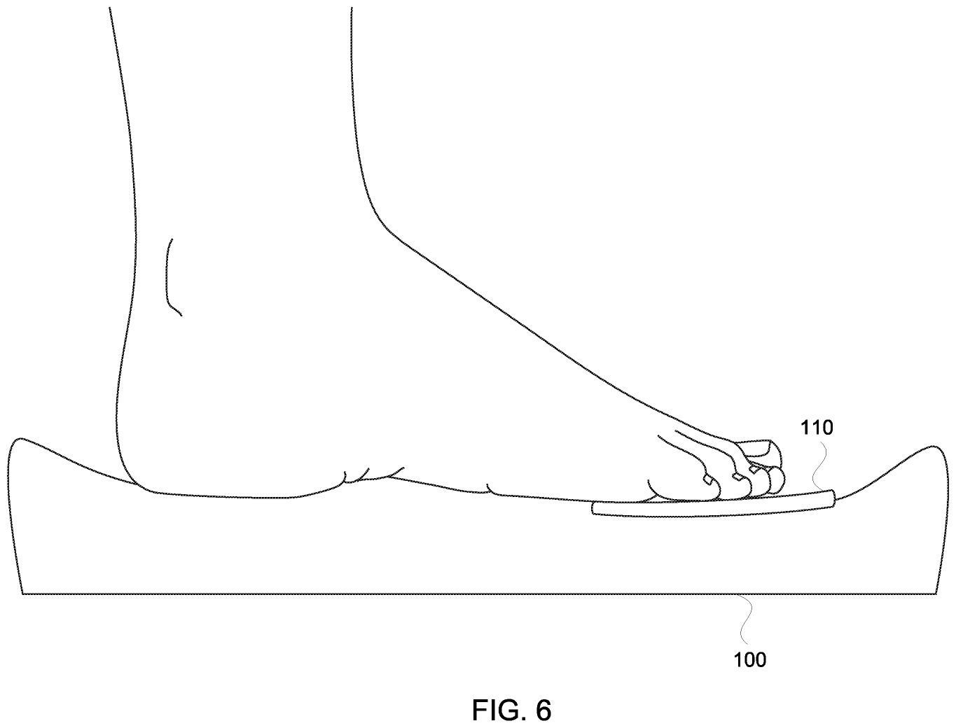

FIG. 6 is a flowchart for a method 600 for using a device for exercising the intrinsic foot muscles of a patient, according to an example embodiment. In step 602, a patient places his/her foot flat on the base 110 with toes resting on top of the toe rest plate 120. In step 604, foot arcing is performed by gripping the toe plate and holding the grip for a predetermined period of time. In step 606, the patient relaxes for another predetermined period of time, and repeats the exercise.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A device for exercising intrinsic foot muscles, the device comprising:
a base formed of a visco-elastic material; and
a solid toe plate coupled to a top of the base, the toe plate shaped to receive the curvature of the bottom of human toes so as to distribute a counterforce from pressure applied by one or more of a plurality of a person's toes among the plurality of the person's toes,
wherein the base is configured to compress as a result of the pressure received when the toe plate is gripped by the person's toes while the person's foot is positioned on top of the base.

2. The device of claim 1, wherein the base and the solid to plate are connected to each other via at least one of an adhesive, stitching, or hook and loop fabrics.

3. The device of claim 1, wherein the device is configured to be used by placing the toe plate on top of the base without otherwise attaching the plate to the base.

4. The device of claim 1, wherein the base comprises a polyurethane flexible foam material.

5. The device of claim 1, wherein the foam material has an indentation forced deflection at 25% deflection test result of 32 lbf or higher.

6. The device of claim 1, wherein the base comprises a rectangular cuboid shape.

7. The device of claim 1, wherein the toe plate is comprised of at least one of a solid plastic, metal, wood, or rubber material.

8. The device of claim 1, wherein the toe plate is comprised of ethylenediamine plastic.

9. A method of using the device of claim 1, the method comprising:
placing a foot on top of the base with toes extending over the toe plate;
gripping the toe plate with the toes for a predetermined period of time.
